(19) United States
(12) Patent Application Publication
(10) Pub. No.: US 2023/0195201 A1
(43) Pub. Date: Jun. 22, 2023

(54) COPROCESSOR POWER MANAGEMENT IN HYBRID ARCHITECTURES

(71) Applicant: Intel Corporation, Santa Clara, CA (US)

(72) Inventors: Junyuan Wang, Shanghai (CN); Timothy Waite, Chandler, AZ (US); Ziye Yang, Shanghai (CN); Hu Chen, Shanghai (CN); Zixuan Li, Shanghai (CN); Anna Czarnowska, Gdansk PM (PL); Olayinka Olubayo, Chandler, AZ (US); Gordon McFadden, Hillsboro, OR (US)

(21) Appl. No.: 18/110,603

(22) Filed: Feb. 16, 2023

(30) Foreign Application Priority Data
Dec. 14, 2022 (WO) PCT/CN2022/138995

(51) Int. Cl. G06F 1/324; G06F 9/50

(52) U.S. Cl. CPC G06F 1/324; G06F 9/5094

(57) ABSTRACT

An accelerator apparatus can include an interface to receive service requests from at least one processing core. The accelerator apparatus can include coprocessor circuitry coupled to the interface and comprised of multiple slices. The coprocessor circuitry can detect a performance type for the at least one processing core. The coprocessor circuitry can operate the plurality of coprocessor slices in at least one of a plurality of power modes based on the performance type detected for the at least one processing core. Some operations can be alternatively performed by an operating system on any processor coupled to the network.

This application claims the benefit of priority to International Application No. PCT/CN2022/138995, filed Dec. 14, 2022, which is incorporated herein by reference in its entirety.

### BACKGROUND

Cloud native (CN) programming is very rapidly emerging programming and services deployment paradigm that allows seamless scalability across functions, highly distributed deployments, demand-based scaling up/down, deployment agility, using a combination of cloud computing and edge computing concepts. CN has become increasing popular as a way to deploy software application workloads.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates a hybrid architecture in which a runtime connection can be implemented in an apparatus according to some embodiments.

FIG. 2 illustrates coprocessor slice power states in a coprocessor according to some embodiments.

FIG. 3 illustrates working modes for a coprocessor having multiple coprocessor slices according to some embodiments.

FIG. 4 illustrates a flowchart of a method for configuring coprocessor slices in accordance with some embodiments.

FIG. 5 illustrates an overview of an Edge cloud configuration for Edge computing.

FIG. 6A provides an overview of example components for compute deployed at a compute node in an edge computing system.

FIG. 6B provides a further overview of example components within a computing device in an edge computing system.

### DETAILED DESCRIPTION

Cloud native (CN) refers to the concept of building and running applications to take advantage of the distributed computing offered by the cloud delivery model. CN applications are designed and built to make use of features and characteristics of the cloud. For example, CN applications can take advantage of the scale, elasticity, resiliency, and flexibility the cloud provides. CN has become an industry popular methodology to deploy software application workloads.

Systems and networks employing CN technology can include multiple computing devices. Many such computing devices have core layouts comprised of multiple cores on a single processor die, with each core being substantially identical in that each core has the same processing capacity and clock speed. More recently, hybrid architectures have been introduced, in which at least two types of cores are provided to perform different tasks. One type of core (e.g., a performance core), can perform more important or larger tasks, while a smaller, more efficient core, can perform background tasks with greater efficiency.

Within this hybrid architecture, management systems (e.g., thread management systems or thread directors) can help an operating system (OS) to schedule workloads to the proper core according to service properties, service polices, etc. Thread management systems can make scheduling decisions based on an offline Machine Learning (ML) model.

Hardware coprocessors and hardware accelerators can also be included with processor dies and/or integrated into processors (e.g., central processing units (CPUs)), to offload core workload while accelerating computer performance. integration and consistency can become more complicated. When a hardware coprocessor or accelerator is integrated into a CPU package (for example as a system on chip (SoC)), both the cores and coprocessors should take a consistent approach to performance and power management. However, with current coprocessor design and implementation, a hardware coprocessor or accelerator often does not or cannot access information regarding which kind of core (e.g., performance core, efficiency core, etc.) a corresponding service is running on.

To address these concerns, some available systems force a coprocessor or accelerator to take a uniform way to manage device power status according to the workload. For example, if a workload is present and/or not empty, firmware or other processing elements or circuitry can change a device power status to Active, or otherwise switch a power status to Idle. However, these and similar solutions are limited in scope to the device/s under control. These solutions do not account for different services that can be operating, or the preference of these service/s or users regarding performance tradeoffs with power, etc. Furthermore, inconsistencies can still result if, for example, a service or application has a particular performance-versus-power efficiency preference while the device has an opposite setting or preference. These inconsistencies can cause more power to be consumed than was expected, or otherwise limit the efficiency savings that could be achieved.

Systems and methods according to some embodiments address these and other concerns by building a runtime connection between cores and coprocessors. The connection can align a coprocessor working mode with a core working mode. Alignment can be done on a per-slice basis, e.g., different subsets of the coprocessor can be controlled separately. Operations can be performed within the accelerators themselves, or by operating systems (OS's) running on processing circuitry within the network, etc. In the context of embodiments, a slice can be thought of as a small service specific Application Specific Integrated Circuit (ASIC). For example, different accelerators can contain or comprise different types or “flavors” of slices. One type or can include, e.g., slices that implement compression algorithms, slices that implement symmetric cryptography, etc. As another example, specific circuitry that perform the multiplication of large numbers for usage in asymmetric cryptography. While certain examples of slices are provided, embodiments are not limited thereto. Further, circuitry can include multiple instances of each slice, which helps scale performance.

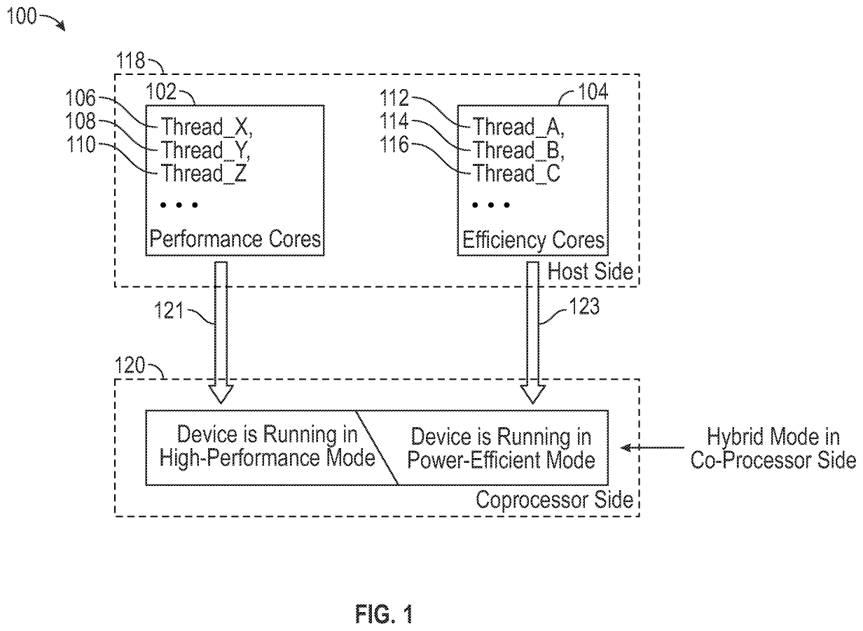

FIG. 1 illustrates a hybrid architecture including an apparatus in which a runtime connection can be implemented according to some embodiments. In FIG. 1, a multi-core system 100 than one processing core. As described above, these can include cores 102 designed for performance (e.g., to process large amounts of data or perform a large volume of operations) quickly. The cores can include other types of cores 104 designed for power efficiency. Other cores can include cores directed to optimizing or complying with SLAs, cores designed to reduce jitteriness, cores designed to preserve bandwidth, or to perform to any other criteria or standard that may be needed in networking and edge environments.

The cores 102, 104 can execute multiple threads 106, 108, 110, 112, 114, 116. In the context of example embodiments, threads can be understood to execute from the host side 118 of the system 100 and make a service request for services on the coprocessor side 120 of the system 100. Some threads (e.g., threads 106, 108 and 110) may have high performance requirements, e.g., servicing must be performed quickly, or large amounts of data are processed. In contrast, other threads (e.g., 112, 114, and 116) may perform background processing or otherwise have low latency requirements or data requirements. Service requests can be provided using application programming interface (API) calls of a particular thread application developer, core developer or customer, etc. In some examples, APIs can define or be used to detect preferred device performance mode. Other interface examples can include telemetry.

In embodiments, a runtime connection 121, 123 can be built between cores 102, 104 and coprocessor/s 120 (e.g., accelerator apparatus/apparatuses) to enable a coprocessor to gain awareness of the type of core (e.g., performance core or processing core) on which a corresponding thread (e.g., service) is running. In some embodiments, this awareness can be gained through hints, metadata, or other configuration data provided by the threads or elements of the corresponding cores. The coprocessor/s can then implement an appropriate work mode to handle service requests. Embodiments of the present disclosure can be used to improve a coprocessor power management mechanism and improving the consistency between coprocessor working mode and core behavior in a hybrid architecture. This can reduce the total power consumption of a processor package, processor die, CPU, etc., thereby reducing costs.

Some of these accelerators provided in the architecture according to example embodiments can include (but are not limited to) Intel® QuickAssist Technology (QAT), IAX or Intel® Data Streaming Accelerator (DSA). Other accelerators can include Cryptographic CoProcessor (CCP) or other accelerators available from Advanced Micro Devices, Inc. (AMD®) of Sunnyvale, Calif. Still further accelerators can include an ARM®-based accelerators available ARM Holdings, Ltd. or a customer thereof, or their licensees or adopters, such as Security Algorithm Accelerators and CryptoCell-300 Family accelerators. Further accelerators can include AI Cloud Accelerator (QAIC) available from Qualcomm® Technologies, Inc. Some FPGA accelerators can include, e.g., Xilinx Deep Learning Solution on AMD EPYC™ processors available from AMD® of Sunnyvale, Calif. Some accelerators can be provided using RISC-V technologies, including AI accelerators, for example.

### Device Hybrid Mode Implementation

A coprocessor can include a number of computing units or resources, referred to hereinafter as coprocessor slices, which can be controlled individually to execute in different power states. By controlling these power states, coprocessors can be controlled to match requirements/needs of various levels of processing cores (e.g., performance cores and efficiency cores) as describe earlier herein. One or more of the functions performed in connection with slice management can be initiated based on user requests (e.g., via a UE), based on a request by a service provider, or maybe triggered automatically in connection with an existing Service Level Agreement (SLA) specifying slice-related performance objectives.

The end-to-end service view for these use cases involves the concept of a service flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real-time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate. Controllers and other aspects of various embodiments can determine when and how to adapt any of the slices or other substructures described herein to meet SLAs.

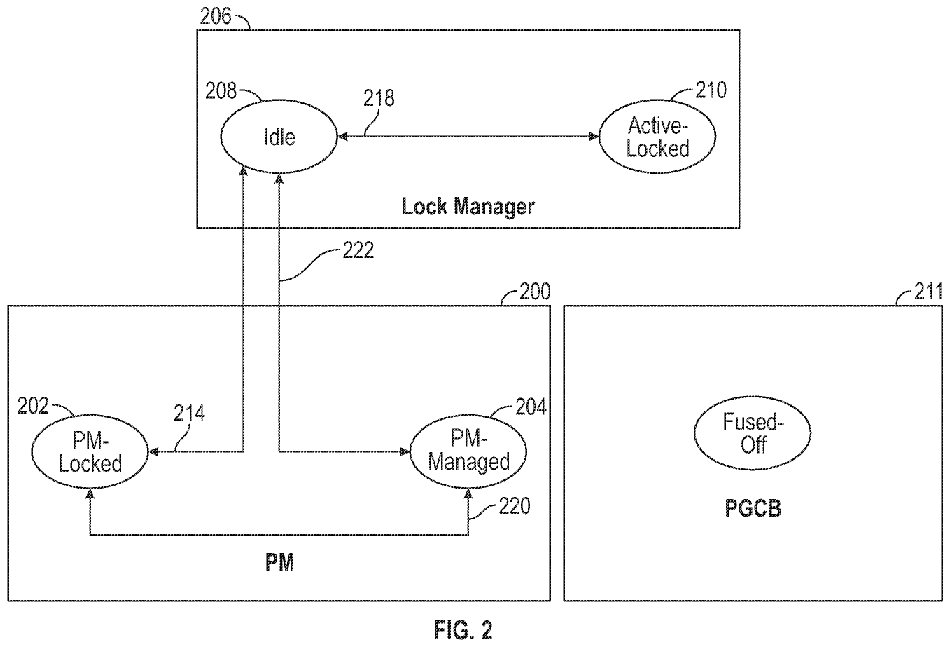

FIG. 2 illustrates coprocessor slice power states in a coprocessor according to some embodiments. While a particular group of states and state definitions are shown in FIG. 2, these are for purposes of clarity and description only, and embodiments are not limited thereto.

In the context of example embodiments for power management a coprocessor slice can exist in an Idle state 208, wherein the coprocessor slice is owned by a Lock Manager 206 but is currently not being used. The coprocessor slice can be clock gated but is available to be granted to a new Service Micro Engine (ME) at any time, wherein the ME can include hardware circuitry to dispatch service request from an application to coprocessor slices. In the context of embodiments, clock gate refers to a technique in which a clock signal is removed (e.g., from synchronous circuits) when the circuit is not in use to save power.

The coprocessor slice can also exist in an Active-Locked state 210, wherein the coprocessor slice is owned by the Lock Manager 206. In the Active-Locked state 210, the coprocessor slice can be fully clocked, has been allocated to a Service ME, and is not available for any new requests, including PM lock requests. Transition 218 can be provided between the Idle state 208 and the Active-Locked state 210.

The coprocessor slice can exist in a PM-Locked state 202 in which the coprocessor slice is owned by the coprocessor slice power module (PM) 200. In PM-Locked state 202, the coprocessor slice is clock gated, and the coprocessor slice can be reset, isolated, and power-gated at any time (wherein power gating refers to a technique to reduce power consumption by shutting of the current to blocks of a circuit (e.g., slices) that are not in use). The coprocessor slice cannot be granted to a new Service ME request. Coprocessor slice PM hardware can autonomously power up and release this coprocessor slice back to the Idle state at transition 214 based on a hardware indication that the coprocessor slice is needed. Once released from reset, the coprocessor slice does need to complete hardware initialization as defined by specifications or other configurations of related vendor hardware, prior to being granted to a Service ME lock request.

The coprocessor slice can exist in a PM-Managed state 204 (e.g., a power-managed state or power-managed mode) in which the coprocessor slice is owned by the coprocessor slice PM 200. In the PM-Managed state 204, the coprocessor slice is clock gated and can be reset, isolated, and power-gated at any time. The coprocessor slice cannot be granted to a new Service ME request.

A coprocessor slice can enter the PM-Managed state 204 when PM hardware has set a particular management bit based on firmware constraints. In embodiments according to the disclosure, this bit can be set only if the coprocessor slice is in the Idle state 208 or the PM-Locked state 202, as showed by transition 220 and transition 222. The coprocessor slice PM 200 hardware can leave the coprocessor slice in this state until power management firmware in accordance with various embodiments causes the PM hardware to release the coprocessor slice. Hardware alone cannot release the coprocessor slice when the coprocessor slice is in the PM-Managed state. Once the coprocessor slice is released hardware initialization can be performed before the coprocessor slice can be granted to a service ME. In the PGCB fused off state 211, a coprocessor slice is permanently power/clock gated and in reset mode.

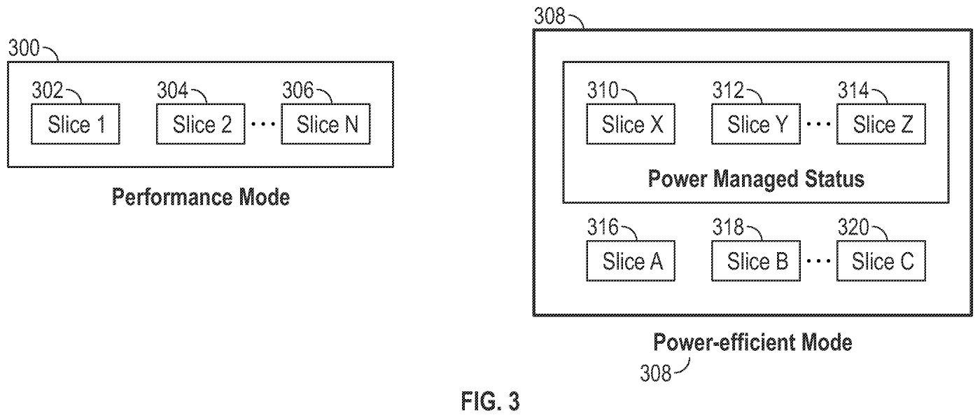

Working modes and policies can be defined for a coprocessor/accelerator. FIG. 3 illustrates working modes for a coprocessor having multiple coprocessor slices according to some embodiments. Referring to FIG. 3, a performance mode 300 can be defined wherein each coprocessor slice 302, 304, 06 is operating at full power and full clock frequency. Alternatively, a power-efficient mode 308 can be defined in which some slices (e.g., slices 310, 312, 314) can be in a power-managed mode or state (see e.g., state 204 (FIG. 2)) while other slices (e.g., slices 316, 318, 320) are not in a power-managed mode, state, or status. While two statuses are described, embodiments are not limited thereto. Furthermore, coprocessors and accelerators can contain any number of slices or sections or memory sharing scenarios.

Any of the slice configurations can be adapted dynamically, based on machine learning or user input or configuration. Further, the number of slices to be placed in a power-managed mode can be configured. Various levels can be predefined or configured. For example, a first level can indicate that no slices are set to power-managed mode, which implies power-efficient mode is disabled. A second level can define a certain percentage of slices to be set to power-managed mode. A third level can define a certain (higher) percentage than the second level, etc.

Different policies can be defined. Consider that coprocessor may be consumed (e.g., used) by multiple processes or services, and one coprocessor slice can further be shared by multiple data requests, some policies can include, if all the services are running on an efficient core (based on a count of the number of services executing, etc.), configuring all coprocessor slices for power-efficient mode (e.g., at a level in which power-managed mode is enabled for all coprocessor slices. Similarly, if all services are running on a performance core, all coprocessor slices can be configured for performance mode. If the coprocessor is consumed my multiple services and some services are running on a performance core and some services are running on an efficient core, all coprocessor slices can be configured for performance, as typically an accelerator (e.g., coprocessor) is used for data processing acceleration, in which case performance is more likely to be preferred over power savings. Otherwise, latency and other performance issues may degrade quality of service (QoS).

### Data Processing Workflow

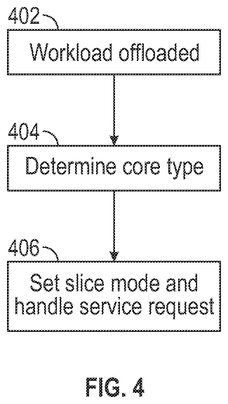

FIG. 4 illustrates a flowchart of a method 400 for configuring coprocessor slices in accordance with some embodiments. The method 400 can begin with operation 402 with a workload being offloaded (e.g., from a CPU or other processor) to an accelerator or coprocessor. The coprocessor can determine the core type of the core from which the workload is being offloaded in operation 404. A field can be added to service requests, e.g., a descriptor field can be provided to indicate which type of core the service is running on host side.

The method 400 can continue with operation 406 with the coprocessor setting a coprocessor slice working mode according to the determinations in operation 404, and further based on policies and other considerations. For example, the level as described above with reference to FIG. 3 can help determine whether any slices are set to performance mode and if so, how many slices are set to performance mode.

Systems and Apparatuses in which Embodiments can be Implemented

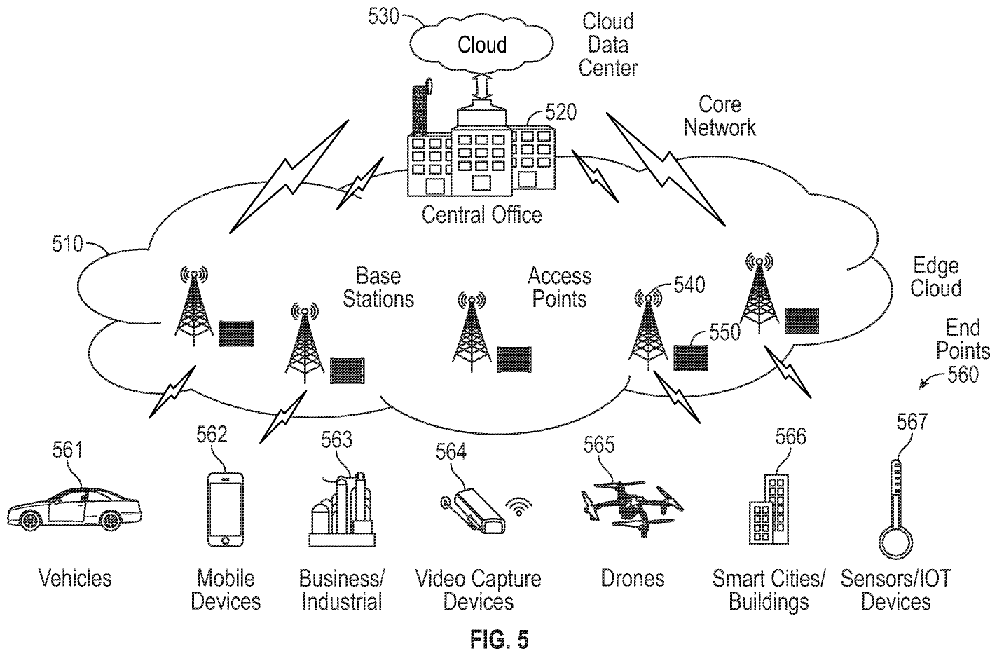

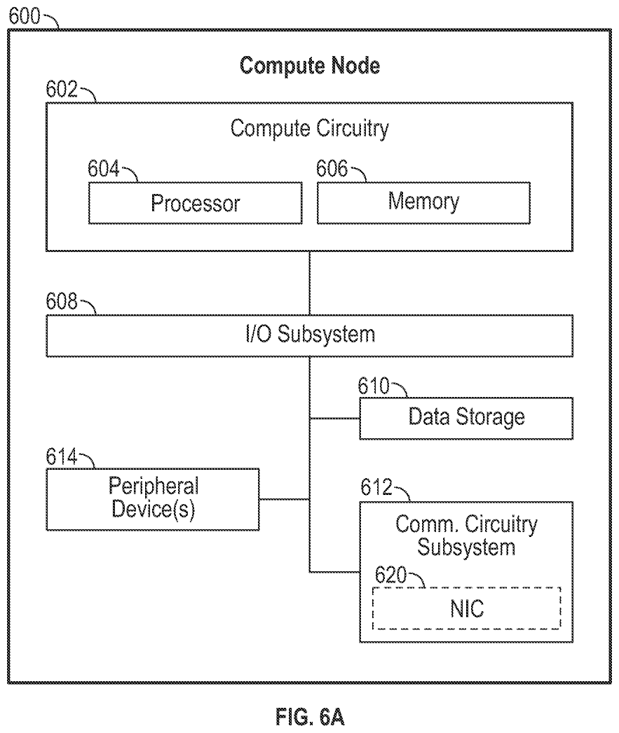

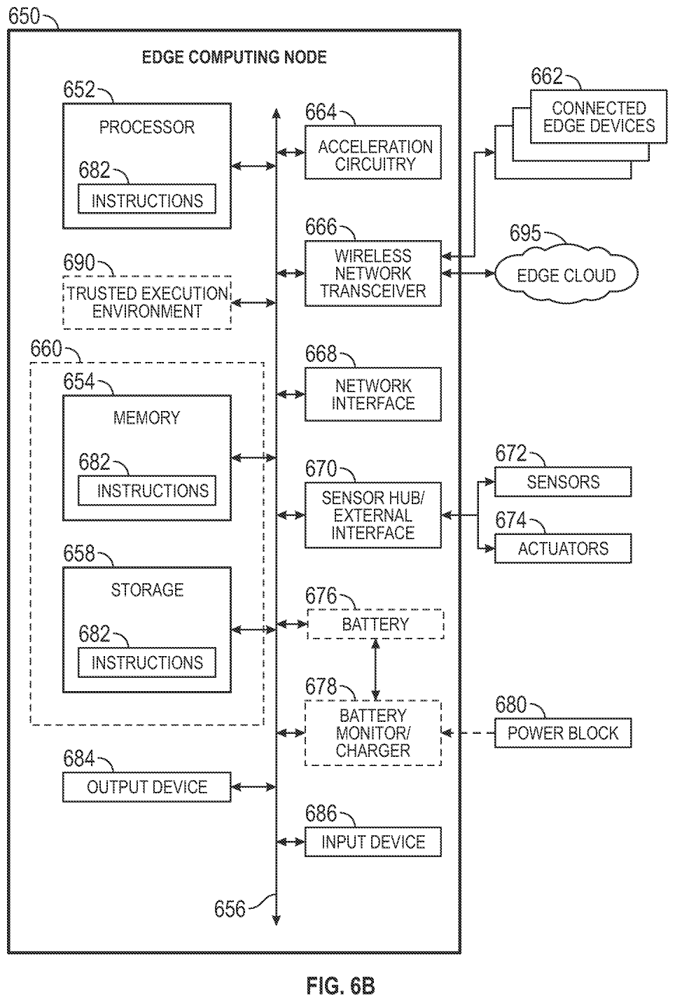

Any of the above-described embodiments can be executed in cloud or edge-based systems as described in FIGS. 5, 6A and 6B.

FIG. 5 is a block diagram showing an overview of a configuration for Edge computing, which includes a layer of processing referred to in many of the following examples as an “Edge cloud.” Accelerators and host systems for accessing the accelerators in accordance with embodiments can be provided within the configuration of FIG. 5, for example within the cloud 530 or any of the end points 560 (although embodiments are not limited thereto). As shown, the Edge cloud 510 is co-located at an Edge location, such as an access point or base station 540, a local processing hub 550, or a central office 520, and thus may include multiple entities, devices, and equipment instances. The Edge cloud 510 is located much closer to the endpoint (consumer and producer) data sources 560 (e.g., autonomous vehicles 561, user equipment 562, business and industrial equipment 563, video capture devices 564, drones 565, smart cities and building devices 566, sensors and IoT devices 567, etc.) than the cloud data center 530. Compute, memory, and storage resources which are offered at the edges in the Edge cloud 510 are critical to providing ultra-low latency response times for services and functions used by the endpoint data sources 560 as well as reduce network backhaul traffic from the Edge cloud 510 toward cloud data center 530 thus improving energy consumption and overall network usages among other benefits.

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate or bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge”, “close Edge”, “local Edge”, “middle Edge”, or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

In further examples, any of the compute nodes or devices discussed with reference to the present Edge computing systems, accelerator and coprocessor methods, and environment may be fulfilled based on the components depicted in FIGS. 6A and 6B. Respective Edge compute nodes may be embodied as a type of device, appliance, computer, or other “thing” capable of communicating with other Edge, networking, or endpoint components. For example, an Edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 6A, an Edge compute node 600 includes a compute engine (also referred to herein as “compute circuitry”) 602, an input/output (I/O) subsystem (also referred to herein as “I/O circuitry”) 608, data storage (also referred to herein as “data storage circuitry”) 610, a communication circuitry subsystem 612, and, optionally, one or more peripheral devices (also referred to herein as “peripheral device circuitry”) 614. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 600 may be embodied as any type of engine, device, or collection of devices capable of performing various compute functions. In some examples, the compute node 600 may be embodied as a single device such as an integrated circuit, an embedded system, a field-programmable gate array (FPGA), a system-on-a-chip (SOC), or other integrated system or device. In the illustrative example, the compute node 600 includes or is embodied as a processor (also referred to herein as “processor circuitry”) 604 and a memory (also referred to herein as “memory circuitry”) 606. The processor 604 may be embodied as any type of processor(s) capable of performing the functions described herein (e.g., executing an application). For example, the processor 604 may be embodied as a multi-core processor(s), a microcontroller, a processing unit, a specialized or special purpose processing unit, or other processor or processing/controlling circuit.

In some examples, the processor 604 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 604 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, storage disks, or AI hardware (e.g., GPUs, programmed FPGAs, or ASICs tailored to implement an AI model such as a neural network). Such an xPU may be designed to receive, retrieve, and/or otherwise obtain programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that an xPU, an SOC, a CPU, and other variations of the processor 604 may work in coordination with each other to execute many types of operations and instructions within and on behalf of the compute node 600.

The memory 606 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

The compute circuitry 602 is communicatively coupled to other components of the compute node 600 via the I/O subsystem 608, which may be embodied as circuitry and/or components to facilitate input/output operations with the compute circuitry 602 (e.g., with the processor 604 and/or the main memory 606) and other components of the compute circuitry 602. For example, the I/O subsystem 608 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 608 may form a portion of a system-on-a-chip (SoC) and be incorporated, along with one or more of the processor 604, the memory 606, and other components of the compute circuitry 602, into the compute circuitry 602.

The one or more illustrative data storage devices/disks 610 may be embodied as one or more of any type(s) of physical device(s) configured for short-term or long-term storage of data. The communication circuitry 612 may be embodied as any communication circuit, device, or collection thereof, capable of enabling communications over a network between the compute circuitry 602 and another compute device (e.g., an Edge gateway of an implementing Edge computing system).

The illustrative communication circuitry 612 includes a network interface controller (NIC) 620, which may also be referred to as a host fabric interface (HFI). The NIC 620 may be embodied as one or more add-in-boards, daughter cards, network interface cards, controller chips, chipsets, or other devices that may be used by the compute node 610 to connect with another compute device (e.g., an Edge gateway node). In some examples, the NIC 620 may be embodied as part of a system-on-a-chip (SoC) that includes one or more processors or included on a multichip package that also contains one or more processors. In some examples, the NIC 620 may include a local processor (not shown) and/or a local memory (not shown) that are both local to the NIC 620. In such examples, the local processor of the NIC 620 may be capable of performing one or more of the functions of the compute circuitry 602 described herein. Additionally, or alternatively, in such examples, the local memory of the NIC 620 may be integrated into one or more components of the client compute node at the board level, socket level, chip level, and/or other levels.

In a more detailed example, FIG. 6B illustrates a block diagram of an example of components that may be present in an Edge computing node 650 for implementing the techniques (e.g., operations, processes, methods, and methodologies) described herein. This Edge computing node 650 provides a closer view of the respective components of node 600 when implemented as or as part of a computing device (e.g., as a mobile device, a base station, server, gateway, etc.). The Edge computing node 650 may include any combination of the hardware or logical components referenced herein, and it may include or couple with any device usable with an Edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the Edge computing node 650, or as components otherwise incorporated within a chassis of a larger system.

The Edge computing device 650 may include processing circuitry in the form of a processor 652, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 652 may be a part of a system on a chip (SoC) in which the processor 652 and other components are formed into a single integrated circuit, or a single package, such as the Edison™ or Galileo™ SoC boards from Intel Corporation, Santa Clara, Calif. As an example, the processor 652 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 652 and accompanying circuitry may be provided in a single socket form factor, multiple socket form factor, or a variety of other formats, including in limited hardware configurations or configurations that include fewer than all elements shown in FIG. 6B.

The processor 652 may communicate with a system memory 654 over an interconnect 656 (e.g., a bus). Any number of memory devices may be used to provide for a given amount of system memory. As examples, the memory 654 may be random access memory (RAM)

The components may communicate over the interconnect 656. The interconnect 656 may include any number of technologies, including industry standard architecture (ISA), extended ISA (EISA), peripheral component interconnect (PCI), peripheral component interconnect extended (PCIx), PCI express (PCIe), or any number of other technologies. Technologies may perform additional functions, such as controlling allocation of internal resources to virtual domains, support various forms of I/O virtualization (e.g., scalable input/output virtualization (scalable IOV)), and other functions. The interconnect 656 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 656 may couple the processor 652 to a transceiver 666, for communications with the connected Edge devices 662. The transceiver 666 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected Edge devices 662. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The Edge computing node 650 may include or be coupled to acceleration circuitry 664, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific Edge computing tasks for service management and service operations discussed elsewhere in this document. The acceleration circuitry 664 can be configured to perform any of the operations above, e.g., configuring performance modes to provide power management on a slice-by-slice basis, or on groups of slices, etc.

In some optional examples, various input/output (I/O) devices may be present within or connected to, the Edge computing node 650. For example, a display or other output device 684 may be included to show information, such as sensor readings or actuator position. An input device 686, such as a touch screen or keypad may be included to accept input. An output device 684 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the Edge computing node 650. A display or console hardware, in the context of the present system, may be used to provide output and receive input of an Edge computing system; to manage components or services of an Edge computing system; identify a state of an Edge computing component or service; or to conduct any other number of management or administration functions or service use cases.

A battery 676 may power the Edge computing node 650, although, in examples in which the Edge computing node 650 is mounted in a fixed location, it may have a power supply coupled to an electrical grid, or the battery may be used as a backup or for temporary capabilities. The battery 676 may be a lithium ion battery, or a metal-air battery, such as a zinc-air battery, an aluminum-air battery, a lithium-air battery, and the like.

A battery monitor/charger 678 may be included in the Edge computing node 650 to track the state of charge (SoCh) of the battery 676, if included. The battery monitor/charger 678 may be used to monitor other parameters of the battery 676 to provide failure predictions, such as the state of health (SoH) and the state of function (SoF) of the battery 676. The battery monitor/charger 678 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 678 may communicate the information on the battery 676 to the processor 652 over the interconnect 656. The battery monitor/charger 678 may also include an analog-to-digital (ADC) converter that enables the processor 652 to directly monitor the voltage of the battery 676 or the current flow from the battery 676. The battery parameters may be used to determine actions that the Edge computing node 650 may perform, such as transmission frequency, mesh network operation, sensing frequency, accelerator configurations, and the like.

The storage 658 may include instructions 682 in the form of software, firmware, or hardware commands to implement the techniques described herein. Although such instructions 682 are shown as code blocks included in the memory 654 and the storage 658, it may be understood that any of the code blocks may be replaced with hardwired circuits, for example, built into an application specific integrated circuit (ASIC).

In an example, the instructions 682 provided via the memory 654, the storage 658, or the processor 652 may be embodied as a non-transitory, machine-readable medium 660 including code to direct the processor 652 to perform electronic operations in the Edge computing node 650. The processor 652 may access the non-transitory, machine-readable medium 660 over the interconnect 656. For instance, the non-transitory, machine-readable medium 660 may be embodied by devices described for the storage 658 or may include specific storage units such as storage devices and/or storage disks that include optical disks (e.g., digital versatile disk (DVD), compact disk (CD), CD-ROM, Blu-ray disk), flash drives, floppy disks, hard drives (e.g., SSDs), or any number of other hardware devices in which information is stored for any duration (e.g., for extended time periods, permanently, for brief instances, for temporarily buffering, and/or caching). The non-transitory, machine-readable medium 660 may include instructions to direct the processor 652 to perform a specific sequence or flow of actions, for example, as described with respect to the flowchart(s) and block diagram(s) of operations and functionality depicted above. As used herein, the terms “machine-readable medium” and “computer-readable medium” are interchangeable. As used herein, the term “non-transitory computer-readable medium” is expressly defined to include any type of computer readable storage device and/or storage disk and to exclude propagating signals and to exclude transmission media.

Also in a specific example, the instructions 682 on the processor 652 (separately, or in combination with the instructions 682 of the machine readable medium 660) may configure execution or operation of a trusted execution environment (TEE) 690. In an example, the TEE 690 operates as a protected area accessible to the processor 652 for secure execution of instructions and secure access to data. Various implementations of the TEE 690, and an accompanying secure area in the processor 652 or the memory 654 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 650 through the TEE 690 and the processor 652.

While the illustrated examples of FIG. 6A and FIG. 6B include example components for a compute node and a computing device, respectively, examples disclosed herein are not limited thereto. As used herein, a “computer” may include some or all of the example components of FIGS. 6A and/or 6B in different types of computing environments. Example computing environments include Edge computing devices (e.g., Edge computers) in a distributed networking arrangement such that particular ones of participating Edge computing devices are heterogenous or homogeneous devices. As used herein, a “computer” may include a personal computer, a server, user equipment, an accelerator, etc., including any combinations thereof. In some examples, distributed networking and/or distributed computing includes any number of such Edge computing devices as illustrated in FIGS. D1A and/or D1B, each of which may include different sub-components, different memory capacities, I/O capabilities, etc. For example, because some implementations of distributed networking and/or distributed computing are associated with particular desired functionality, examples disclosed herein include different combinations of components illustrated in FIGS. 6A and/or 6B to satisfy functional objectives of distributed computing tasks. In some examples, the term “compute node” or “computer” only includes the example processor 604, memory 606 and I/O subsystem 608 of FIG. 6A. In some examples, one or more objective functions of a distributed computing task(s) rely on one or more alternate devices/structure located in different parts of an Edge networking environment, such as devices to accommodate data storage (e.g., the example data storage 610), input/output capabilities (e.g., the example peripheral device(s) 614), and/or network communication capabilities (e.g., the example NIC 620).

In the illustrated examples of FIGS. 6A and 6B, computing devices include operating systems. As used herein, an “operating system” is software to control example computing devices, such as the example Edge compute node 600 of FIG. 6A and/or the example Edge compute node 650 of FIG. 6B. Example operating systems include but are not limited to consumer-based operating systems (e.g., Microsoft® Windows® 10, Google® Android® OS, Apple® Mac® OS, etc.). Example operating systems also include, but are not limited to industry-focused operating systems, such as real-time operating systems, hypervisors, etc. An example operating system on a first Edge compute node may be the same or different than an example operating system on a second Edge compute node. In some examples, the operating system invokes alternate software to facilitate one or more functions and/or operations that are not native to the operating system, such as particular communication protocols and/or interpreters. In some examples, the operating system instantiates various functionalities that are not native to the operating system. In some examples, operating systems include varying degrees of complexity and/or capabilities. For instance, a first operating system corresponding to a first Edge compute node includes a real-time operating system having particular performance expectations of responsivity to dynamic input conditions, and a second operating system corresponding to a second Edge compute node includes graphical user interface capabilities to facilitate end-user I/O.

Example 1 is an accelerator apparatus, comprising: an interface to receive service requests from at least one processing core; and coprocessor circuitry coupled to the interface and, the coprocessor circuitry comprised of a plurality of coprocessor slices, the coprocessor circuitry configured to: detect a performance type for the at least one processing core; and operate the plurality of coprocessor slices in at least one of a plurality of power modes based on the performance type detected for the at least one processing core.

In Example 2, the subject matter of Example 1 can optionally include wherein the performance type includes a performance type, an efficiency type.

In Example 3, the subject matter of Example 2 can optionally include wherein the coprocessing circuitry is further configured to configure the plurality of power modes based on a policy, the policy being determined based at least on a count of services executing on at least two different types of processing cores.

In Example 4, the subject matter of Example 3 can optionally include wherein the policy comprises setting at least a subset of the plurality of coprocessor slices to a power-managed mode, wherein the power-managed mode in which a corresponding coprocessor slice is clock gated.

In Example 5, the subject matter of Example 4 can optionally include wherein the policy comprises setting all of the plurality of coprocessor slices to a power-managed mode.

In Example 6, the subject matter of Example 3 can optionally include wherein the policy comprises setting zero of the plurality of coprocessor slices to a power-managed mode to disable power-efficient operations.

In Example 7, the subject matter of any of Examples 1-6 can optionally include wherein the coprocessor circuitry comprises a system on chip (SoC).

In Example 8, the subject matter of any of Examples 1-7 can optionally include wherein the coprocessor circuitry comprises a field programmable gate array (FPGA).

In Example 9, the subject matter of any of Examples 1-8 can optionally include wherein the service requests are provided or received through application programming interface (API) function calls.

In Example 10, the subject matter of Example 9 can optionally include wherein the API function calls define a preferred slice type or other parameter of coprocessor functionality.

Example 11 is a computer-readable medium for performing any of Examples 1-10.

Example 12 is a method for performing any of Examples 1-10.

Example 13 is a system comprising means for performing any of Examples 1-10.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. An accelerator apparatus, comprising:
an interface to receive service requests from at least one processing core; and
coprocessor circuitry coupled to the interface and, the coprocessor circuitry comprised of a plurality of coprocessor slices, the coprocessor circuitry configured to:
detect a performance type for the at least one processing core; and
operate the plurality of coprocessor slices in at least one of a plurality of power modes based on the performance type detected for the at least one processing core.

2. The accelerator apparatus of claim 1, wherein the performance type includes at least one of a performance type and an efficiency type.

3. The accelerator apparatus of claim 2, wherein the coprocessor circuitry is further configured to configure the plurality of power modes based on a policy, the policy being determined based at least on a count of services executing on at least two different types of processing cores.

4. The accelerator apparatus of claim 3, wherein the policy comprises setting at least a subset of the plurality of coprocessor slices to a power-managed mode, wherein the power-managed mode in which a corresponding coprocessor slice is clock gated.

5. The accelerator apparatus of claim 4, wherein the policy comprises setting all of the plurality of coprocessor slices to a power-managed mode.

6. The accelerator apparatus of claim 3, wherein the policy comprises setting zero of the plurality of coprocessor slices to a power-managed mode to disable power-efficient operations.

7. The accelerator apparatus of claim 1, wherein the coprocessor circuitry comprises a system on chip (SoC).

8. The accelerator apparatus of claim 1, wherein the coprocessor circuitry comprises a field programmable gate array (FPGA).

9. The accelerator apparatus of claim 1, wherein the service requests are provided or received through application programming interface (API) function calls.

10. A computer-readable medium including instructions that, when executed on a device, cause the device to perform operations including:
receiving service requests from at least one processing core;
detecting a performance type for the at least one processing core; and
operate a plurality of coprocessor slices in at least one of a plurality of power modes based on the performance type detected for the at least one processing core.

11. The computer-readable medium of claim 10, wherein the performance type includes one of performance or efficiency.

12. The computer-readable medium of claim 11, further comprising configuring the plurality of power modes based on a policy, the policy being determined based at least on a count of services executing on each type of processing core.

13. The computer-readable medium of claim 12, wherein the policy comprises setting all coprocessor slices to a power-managed mode.

14. The computer-readable medium of claim 12, wherein the policy comprises setting zero coprocessor slices to a power-managed mode to disable power-efficient operations.

15. The computer-readable medium of claim 10, wherein the service requests are provided or received through application programming interface (API) function calls.

16. The computer-readable medium of claim 15, wherein the API function calls define a preferred slice type or other parameter of coprocessor functionality.

17. A method comprising:
receiving service requests from at least one processing core;
detecting a performance type for the at least one processing core; and
operating a plurality of coprocessor slices in at least one of a plurality of power modes based on the performance type detected for the at least one processing core.

18. The method of claim 17, wherein the performance type includes one of a performance or efficiency.

19. The method of claim 18, further comprising configuring the plurality of power modes based on a policy, the policy being determined based at least on a count of services executing on each type of processing core.

20. The method of claim 19, wherein the policy comprises setting at least a subset of the plurality of coprocessor slices to a power-managed mode, wherein the power-managed mode in which a corresponding coprocessor slice is clock gated.
